(19) United States
(12) Patent Application Publication
(10) Pub. No.: US 2007/0208666 A1
(43) Pub. Date: Sep. 6, 2007

(54) METHOD OF PAYING TOLL FOR MOBILE TELEPHONES

(75) Inventors: Darwin He, Shanghai (CN); Steven Broeils Luitjens, Eindhoven (NL); Gongming Wei, Shanghai (CN); Wenying You, i (CN); Wilhelmus Franciscus Johannes Fontijn, Eindhoven (NL); Feng Li, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,476

(22) PCT Filed: Mar. 24, 2005
(86) PCT No.: PCT/IB05/51026

§ 371 Date: Sep. 29, 2006

(30) Foreign Application Priority Data
Apr. 2, 2004 (EP) 04101374.9

(51) Int. Cl. G06Q 10/00

(52) U.S. Cl. 705/52

(57) ABSTRACT

There is described a communication apparatus (10) for communicating via one or more services provided by a service provider (80). The apparatus (10) is preferably a mobile telephone. Moreover, the apparatus (10) includes a memory device (30) susceptible to receive one or more data carriers (20) distributed by the provider (80) in return for payment. The device (30) is operable on presentation of the one or more data carriers (20) thereto to directly access data (60, 65, 300) on the one or more data carriers (20). Furthermore, the apparatus (10) is further arranged to be capable of communicating the data (60) to the provider (80) for the provider (80) to check the data (60) for updating a toll credit for the apparatus (10) according to information conveyed in the data (60) when the data (60) is found to be valid. Use of the data carrier (20) enables advertising and addresses problems encountered when, for example, using contemporary scratch cards for toll crediting purposes.

### FIELD OF THE INVENTION

The present invention relates to methods of paying tolls for mobile telephones and similar communication apparatus; in particular, but not exclusively, the invention relates to a method of paying tolls for mobile telephones using removable miniature data carriers, for example miniature optical disk data carriers. Moreover, the invention also relates to communication apparatus and associated communication systems arranged to implement the method.

### BACKGROUND TO THE INVENTION

Pre-paid cards for adding toll credits for mobile telephones users are well known. Such cards can be bought at retailing premises, for example kiosks, automobile gas stations and supermarkets. The cards are each provided with a corresponding unique printed code number. The code numbers of the cards are often hidden by way of scratch-off opaque protection which is arranged to be user removable. When invoking credits associated with the cards, the users remove the scratch protection and subsequently ring to relevant communication service providers. Thereafter, the users input, for example by typing on mobile telephone keypads, the unique codes into their mobile telephones, these codes being thereby communicated to the service providers. The providers receive the unique numbers, verify the numbers to be authentic and valid, and then credit toll ratings of the users. The toll ratings permit corresponding users to make telephone calls via the communication services.

It is also known to provide service activation by using virtual prepaid cards as described in a published U.S. patent application No. US2003/0014360. The service activation is directed at addressing a problem of illegitimate use of virtual prepaid cards. The prepaid cards are arranged to be scratchable for revealing their associated first codes which are communicated in use to a server of a communication service provider. Corresponding second codes are delivered on user payment for the cards. The first and second codes are then authenticated for their respective users so that the users are capable of using the service provider for communication purposes using the first codes.

### SUMMARY OF THE INVENTION

The inventors have appreciated that a problem arises with the use of prepaid cards in that the cards include long numbers which need to be entered accurately into mobile telephones to invoke credits associated with the prepaid cards. Such long numbers are neither convenient nor intuitive; frustration is often encountered when users incorrectly enter inaccurate data via mobile telephone keyboards. Elderly people having poor eyesight and/or cognitive abilities often encounter problems entering such numbers. These elderly people are required to call a server of a communication service provider and then input prepaid scratch-card code numbers which can often comprise up the 15 to 20 decimal digits. On receipt of the code numbers, the service provider credits the user accounts of the elderly people and simultaneous prohibit use of the code numbers for subsequent crediting purposes. After data entry, the prepaid scratch cards are of no further use and are therefore normally discarded.

The inventors have therefore devised an alternative approach for paying tolls for mobile telephones and similar communication apparatus.

An object of the present invention is to provide a method of paying toll for communication apparatus which is easier and more convenient.

According to a first aspect of the present invention, there is provided a method of paying toll for communication apparatus operable to communicate via one or more services provided by a service provider, the method comprising steps of:

(a) arranging for the service provider to distribute one or more data carriers for retail in return for payment to the provider;

(b) arranging for the apparatus to include a memory device susceptible to receiving the one or more data carriers;

(c) presenting the one or more data carriers to the memory device for enabling the apparatus via the device to directly access data recorded on the one or more data carriers;

(d) communicating the data via the apparatus to the provider;

(e) receiving the data at the provider and checking thereat validity of the data; and

(f) updating a toll credit for the apparatus according to information conveyed in the data when the data is found by the provider to be valid.

The invention is of advantage in that direct access to data on the one or more data carriers is feasible without a user of the apparatus needing to transcribe data as arises conventionally.

Preferably, in the method, the one or more data carriers are susceptible to optical and/or magnetic interrogation for reading the data therefrom. Such carriers are potentially inexpensive and compact and therefore well suited for users to regularly update their credit allowances. More preferably, the one or more data carriers are one or more small form factor optical (SFFO) disks data carriers; such carriers are especially preferred because they are susceptible to additionally including advertisement material which can be presented to the user of the apparatus.

Preferably, in the method, the data includes at least one secured number for conveying information for identifying the one or more data carriers. For enhancing security against abuse, for example fraud and/or unauthorised copying of the one or more data carriers, the at least one secured number is preferably maintained in a secure keylocker structure recorded on the one or more data carriers, said keylocker being accessible to the service provider on presentation of a valid access key to the apparatus.

Preferably, to enhance security and thereby prevent fraud, the method includes a step of communicating the data on the data carrier to the service provider in encrypted form.

Preferably, in the method, the service provider is operable to check for earlier invocation of the data directly accessed from the one or more data carriers, thereby identifying whether or not credit represented by the one or more data carriers has earlier been credited in association with the apparatus. Such checking assist to reduce a risk of fraudulent toll crediting.

Preferably, in the method, the one or more data carriers include advertisement data content and/or at least one advertisement software application for presenting advertisement material to a user of the apparatus when the one or more data carriers are presented to the device. More preferably, the material is presented in at least one of audio format and visual format to the user. Beneficially, in the method, the one or more carriers include bonus content supplied by a telecommunications provider to attract more toll subscribers, for example the bonus content includes one or more of free games, attractive pictures and images, and pre-authored Multimedia Messaging Services (MMS).

According to a second aspect of the invention, there is provided a communication apparatus for communicating via one or more services provided by a service provider, said apparatus including a memory device susceptible to receive one or more data carriers distributed by the provider in return for payment, the device being operable on presentation of the one or more data carriers thereto to directly access data on the one or more data carriers, the apparatus being further arranged to be capable of communicating the data to the provider for the provider to check the data for updating a toll credit for the apparatus according to information conveyed in the data when the data is found to be valid.

According to third aspect of the present invention, there is provided a communication system including a service provider and at least one communication apparatus, wherein each of said at least one apparatus is arranged to communicate via one or more services provided by a service provider, said apparatus including a memory device susceptible to receive one or more of the data carriers distributed by the provider in return for payment, the device being operable on presentation of the one or more data carriers thereto to directly access data on the one or more data carriers, the apparatus being further arranged to be capable of communicating the data to the provider for the provider to check the data for updating a toll credit for the apparatus according to information conveyed in the data when the data is found to be valid.

According to a fourth aspect of the present invention, there is provided a data carrier suitable for use in the method of the first aspect of the invention for conveying the data, the carrier being susceptible to being read directly by the device. More preferably, the data is recorded in a secure keylocker structure of the carrier. Yet more preferably, the data carrier further includes advertisement data content and/or advertisement application software for presenting advertisements to a user of the carrier. Most preferably, the carrier is implemented as a small form factor optical disk data carrier.

According to a fifth aspect of the present invention, there is provided software operable to implement the method according to the first aspect of the invention.

According to a sixth aspect of the present invention, there is provided a communication system comprising a mobile terminal comprising an interface for receiving a data carrier, a server comprising a database, the data carrier comprising data content and an area for secure data, and a data connection for transferring the secure data via a network, said communication system being programmed to automatically access and send the secure data stored on the data carrier from the mobile terminal via the data connection to the server, after insertion of the data carrier into the mobile terminal, the mobile terminal being further adapted to retrieve data content from the data carrier for presentation at the terminal.

By having a device that is able to access data content from the data carrier, transfer of large amounts of data by wireless through a communication network to the mobile terminal can be circumvented; instead, the device is capable of accessing such data immediately from the data carrier, for example accessing advertisement data content for presentation at the terminal.

Furthermore, the mobile device is capable of accessing data content which can be information of any kind from the data carrier, even at places where the mobile terminal does not have communication coverage, for example in radio shadows such as in tunnels or other isolated places.

It will be appreciated that features of the invention are susceptible to being combined in any combination without departing from the scope of the invention.

### DESCRIPTION OF THE DIAGRAMS

Embodiments of the invention will now be described, by way of example only, with reference to the following diagrams wherein:

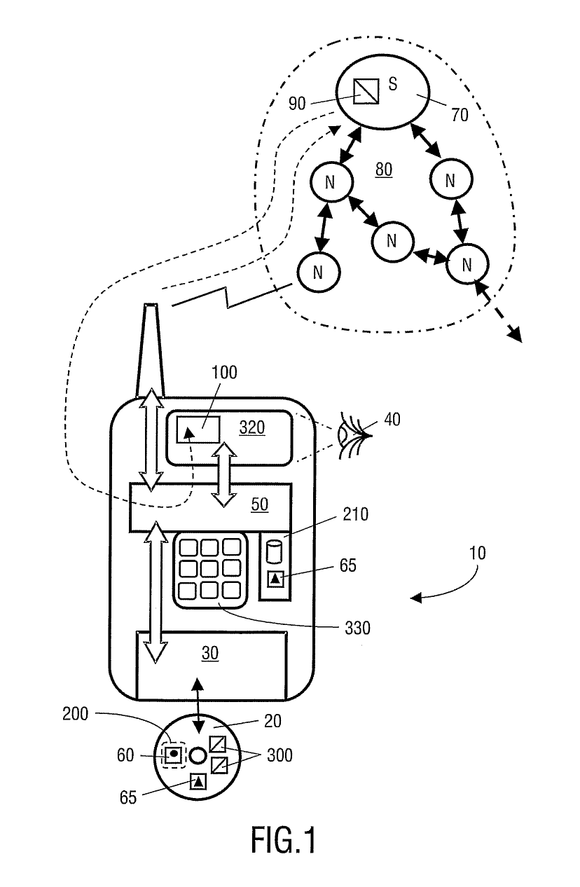

FIG. 1 is a schematic diagram of a communication apparatus, for example a mobile telephone, coupled in communication with a service provider for implementing a method of paying toll according to the invention; and

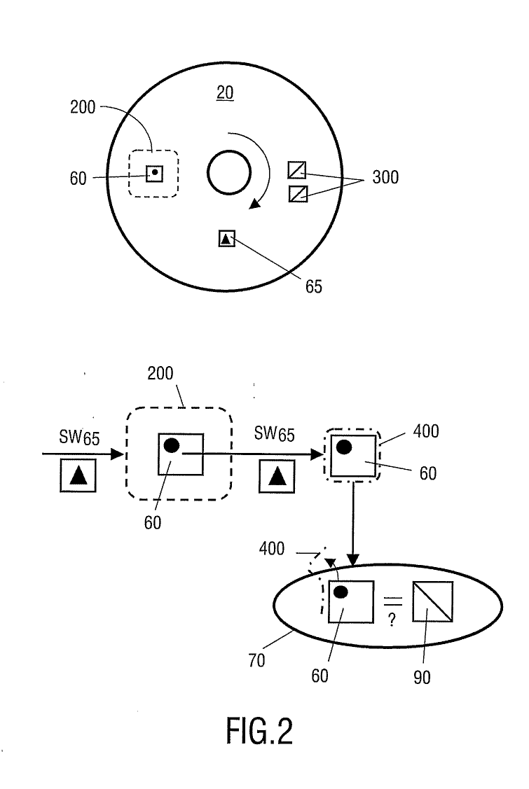

FIG. 2 is a schematic representation of data structures included on a data carrier used in the method pertaining to FIG. 1, and a sketch illustrating data flow between the apparatus and the service provider.

### DESCRIPTION OF EMBODIMENTS OF THE INVENTION

In overview with reference to FIG. 1, the inventors have devised an alternative method of paying tolls for a mobile telephone indicated generally by 10 and similar types of communication apparatus. The method involves the use of a removable data carrier 20 which is automatically readable by the telephone 10 when inserted into a disk drive 30 of the telephone 10 without there being a need for a user 40 of the telephone 10 to convey data from the data carrier 20 to the telephone 10. By using the automatically-readable data carrier 20, it is feasible to employ more robust verification and thereby more effectively avoid potential fraud. The data carrier 20 is preferably at least one of an optically readable data carrier and a magnetically readable data carrier; for example, the data carrier 20 is preferably a miniature optical data carrier susceptible to being interrogated using substantially blue-wavelength optical radiation. An example of such a data carrier is Philips N.V.'s proprietary small form factor optical (SFFO) data disk capable of conveying and/or storing up to substantially 1.5 Gbytes of data content.

In operation, the user 40 inserts the data carrier 20 into the disk drive 30 of the telephone 10. Thereafter, the user 40 invokes a credit validation program 65 which executes in data processing hardware 50 of the telephone 10 to load a secured number 60 from the inserted data carrier 20 and communicate it to a server 70 of a communication service provider 80; the service provider 80 is preferably a communication network including several interconnected nodes (N) and one or more servers (S). The server 70 receives the secured number 60 and then proceeds to verify the secured number 60 against its own data records 90 as being authentic. If the server 70 finds the secured number 60 to be bona fide and not previously user-invoked, the server 70 updates a credit rating of the user 40 accordingly; conversely, if the number 60 is found to be incorrect or to have been invoked previously for crediting purposes, the server 70 returns an error message 100 to the mobile telephone 10 to inform the user 40. Previous invocation of the secured number 60 can potentially arise where the data carrier 20 has been copied and multiple unauthorised pirate copies of the carrier 20 then subsequently fraudulently distributed.

Data conveyed on the data carrier 20 is rendered more robust by use of a SFFO key-locker 200 as illustrated in FIG. 2. The key-locker 200 is preferably implemented as a data area on the carrier 20 which is subject to encryption and its data including the secured number 60 therefore only decipherable when using appropriate decryption software employing suitable decryption keys. Thus preferably, the aforementioned credit validation program 65 is operable to allow the server 70 access to the secured number 70 on presentation of a suitable access key to the validation program 65. Preferably, the validation program 65 is operable to communicate the secured number 60 to the server 70 in encrypted form as denoted by 400. Preferably, the access key used by the server 70 to gain access to the secured number 60 on the data carrier 20 is mutually different to a decryption key needed to decode the secured number at the server 70.

The validation program 65 can either be provided on the data carrier 20 or be stored in non-removable memory, for example in a read only memory 210 of the mobile telephone 10 and therefore difficult for third parties to copy.

The data carrier 20 is preferably also arranged to include data content such as one or more free software applications 300. On insertion of the data carrier 20 into the telephone 10, the one or more free software applications 300 can be automatically invoked by the hardware 50 to present advertisements and other promotional images on a display 320 of the mobile telephone 10. Free promotional images presented beneficially include one or more standard messaging system (SMS) images for inclusion when composing SMS messages; the SMS images preferably promote services of the communication service provider 80 and can for attracting attention comprise one or more interactive games or puzzles. These SMS images are preferably capable of being communicated to other users when making telephone calls using the telephone 10, thereby spreading user awareness of the service provider 80 and its associated services.

The data carrier 20 is susceptible to being purchased in a manner akin to contemporary prepaid scratch cards. However, the data carrier 20 is of benefit in that the user 40 is not expected to input long sequences of numerals accurately into the telephone 10, for example into a keyboard 330 of the telephone 10. Thus, elderly persons having poor eyesight and/or cognitive abilities will be able to associate insertion of the data carrier 20 into the telephone 10 as a “key” for obtaining services, rather akin to feeding coins to pay for a call when using a public telephone; in contradistinction, entry of the aforementioned long sequence of numbers is cognitively more complex for such elderly people to comprehend.

Use of the data carrier 20 is also of benefit to the communication provider 80 in that it provides an opportunity for advertisement which is not effectively provided with prepaid scratch cards. For example, the one or more free software applications 300 are beneficially animated to attract the user's 40 attention and interest. Advertisements presented on the display 320 to the user 40 are preferably at least one of visually and audibly implemented, such audio implementation being especially useful when the user 40 has poorer eyesight.

In the accompanying claims, numerals and other symbols included within brackets are intended to assist understanding of the claims and are not intended in any way to limit the scope of the claims.

It will be appreciated that embodiments of the invention described in the foregoing are susceptible to being modified without departing from the scope of the invention as defined by the accompanying claims.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

1-16. (canceled)

17. A method of paying toll for communication apparatus (10) operable to communicate via one or more services provided by a service provider (80), the method comprising steps of:
(a) arranging for the service provider (80) to distribute one or more data carriers (20) for retail in return for payment to the provider (80);
(b) arranging for the apparatus (10) to include a memory device (30) susceptible to receiving the one or more data carriers (20);
(c) presenting the one or more data carriers to the memory device (30) for enabling the apparatus (10) via the device (30) to directly access data (60) recorded on the one or more data carriers (20), wherein the data (60) includes at least one secured number (60) for conveying information for identifying the one or more data carriers (20), the at least one secured number (60) being maintained in a secure keylocker structure (200) recorded on the one or more data carriers (20), said keylocker (200) being accessible to the service provider (80) on presentation of a valid access key to the apparatus (10);
(d) communicating the data (60) including the at least one second number via the apparatus (10) to the provider (80);
(e) receiving the data at the provider (70, 80) and checking thereat validity of the data (60); and
(f) updating a toll credit for the apparatus (10) according to information conveyed in the data (60) when the data (60) is found by the provider (70, 80) to be valid.

18. A method according to claim 17, wherein the one or more data carriers (20) are susceptible to optical and/or magnetic interrogation for reading the data (60) therefrom.

19. A method according to claim 17, wherein the one or more data carriers (20) are one or more small form factor optical (SFFO) disks data carriers.

20. A method according to claim 17, including a step of communicating the data (60) on the data carrier (20) to the service provider (80) in encrypted form.

21. A method according to claim 17, wherein the service provider (80) is operable to check for earlier invocation (90) of the data (60) directly accessed from the one or more data carriers (20), thereby identifying whether or not credit represented by the one or more data carriers (20) has earlier been credited in association with the apparatus (10).

22. A method according to claim 17, wherein the one or more data carriers (20) include advertisement data content (300) and/or at least one advertisement software application (300) for presenting advertisement material to a user (40) of the apparatus (10) when the one or more data carriers (20) are presented to the device (30).

23. A communication apparatus (10) for communicating via one or more services provided by a service provider (80), said apparatus (10) including a memory device (30) susceptible to receive one or more data carriers (20) distributed by the provider (80) in return for payment, the device (30) being operable on presentation of the one or more data carriers (20) thereto to directly access data (60) on the one or more data carriers (20), wherein the data (60) includes at least one secured number (60) for conveying information for identifying the one or more data carriers (20), the at least one secured number (60) being maintained in a secure keylocker structure (200) recorded on the one or more data carriers (20), said keylocker (200) being accessible to the service provider (80) on presentation of a valid access key to the apparatus (10), the apparatus (10) being further arranged to be capable of communicating the data (60) to the provider (80) for the provider (80) to check the data for updating a toll credit for the apparatus (10) according to information conveyed in the data (60) when the data (60) is found to be valid.

24. A communication system (10, 80) including a service provider (80) and at least one communication apparatus (10), wherein each of said at least one apparatus (10) is arranged to communicate via one or more services provided by a service provider (80), said apparatus (10) including a memory device (30) susceptible to receive one or more of the data carriers (20) distributed by the provider (80) in return for payment, the device (10) being operable on presentation of the one or more data carriers (20) thereto to directly access data (60) on the one or more data carriers (20), wherein the data (60) includes at least one secured number (60) for conveying information for identifying the one or more data carriers (20), the at least one secured number (60) being maintained in a secure keylocker structure (200) recorded on the one or more data carriers (20), said keylocker (200) being accessible to the service provider (80) on presentation of a valid access key to the apparatus (10), the apparatus (10) being further arranged to be capable of communicating the data (60) to the provider (80) for the provider (80) to check the data (60) for updating a toll credit for the apparatus (10) according to information conveyed in the data (60) when the data (60) is found to be valid.

25. A data carrier (20) suitable for use in the method of claim 17 for conveying the data (60), the carrier (20) being susceptible to being read directly by the device (30), wherein the data (60) is recorded in a secure keylocker structure (200) of the carrier (20).

26. A carrier (20) according to claim 25, further including advertisement data content (300) and/or advertisement application software (300) for presenting advertisements to a user (40) of the carrier (20).

27. A carrier (20) according to claim 25 implemented as a small form factor optical disk data carrier.

28. Software (65) operable to implement the method according to claim 17.
